(19) United States
(12) Patent Application Publication
(10) Pub. No.: US 2019/0311558 A1
(43) Pub. Date: Oct. 10, 2019

(54) METHOD AND APPARATUS TO ISOLATE AN ON-VEHICLE FAULT

(71) Applicant: GM Global Technology Operations LLC, Detroit, MI (US)

(72) Inventors: Anil Bika, Rochester Hills, MI (US); Azeem Sarwar, Rochester Hills, MI (US); Nathan Thompson, Sterling Heights, MI (US); Jason Prince, Fraser, MI (US); James J. Kelly, III, Detroit, MI (US); Steven J. Samolinski, Rocheser Hills, MI (US)

(73) Assignee: GM Global Technology Operations LLC, Detroit, MI (US)

(21) Appl. No.: 15/949,255

(22) Filed: Apr. 10, 2018

(51) Int. Cl. G07C 5/08

(52) U.S. Cl. CPC G07C 5/0808; G07C 5/085

(57) ABSTRACT

A non-integrated monitoring device and method for monitoring a subject vehicle includes monitoring, via a non-integrated sensor, a physical parameter being emitted from the subject vehicle. The physical parameter being emitted from the subject vehicle is analyzed to determine a dynamic signature for the subject vehicle. A baseline signature for the subject vehicle is obtained, and compared to the dynamic signature for the subject vehicle. Occurrence of a fault in a subsystem of the subject vehicle is detected based upon the comparing of the baseline signature for the subject vehicle and the dynamic signature for the subject vehicle, and the occurrence of the fault is communicated to an operator of the subject vehicle.

### INTRODUCTION

Vehicles and vehicle operators may benefit from on-board monitoring systems that detect occurrence of a fault or another indication of a need for service and/or vehicle maintenance.

### SUMMARY

A non-integrated monitoring device and method for monitoring a machine or a subject vehicle is described, and includes monitoring, via a non-integrated sensor, a physical parameter being emitted from the machine or subject vehicle. The physical parameter being emitted is analyzed to determine a dynamic signature. A baseline signature is obtained, and compared to the dynamic signature. Occurrence of a fault in a subsystem is detected based upon the comparing of the baseline signature and the dynamic signature, and the occurrence of the fault is communicated to an operator.

An aspect of the disclosure includes the non-integrated sensor being disposed proximal to the machine or subject vehicle.

Another aspect of the disclosure includes monitoring acoustic sound via a non-integrated microphone.

Another aspect of the disclosure includes the physical parameter being acoustic sound, and wherein determining the dynamic signature includes executing a frequency spectrum analysis of the acoustic sound being emitted from the machine or subject vehicle.

Another aspect of the disclosure includes monitoring vibration via a non-integrated accelerometer.

Another aspect of the disclosure includes monitoring temperature via a non-integrated temperature sensor.

Another aspect of the disclosure includes determining a dynamic signature corresponding to a rotational speed of the rotatable element when the subsystem includes a rotatable element.

Another aspect of the disclosure includes accessing, via a telematics device, a database stored on a remotely located server to obtain the baseline data for the machine or subject vehicle.

Another aspect of the disclosure includes uploading the dynamic signature to the database stored on the remotely located server.

Another aspect of the disclosure includes the baseline signature for the machine or subject vehicle being crowd-sourced.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows a vehicle including a plurality of subsystems and a vibration-based monitoring system, in accordance with the disclosure;

FIG. 2 schematically shows a process to detect and isolate a fault associated with one of the subsystems, in accordance with the disclosure;

FIG. 3 schematically shows a process for capturing information associated with operation of the vehicle for collection, data analysis, and data compression, and communication to an off-board server, in accordance with the disclosure;

FIG. 4 schematically shows a routine associated with compiling and communicating service information related to monitoring, fault diagnostics, repair and updating service information for an embodiment of the vehicle described with regard to FIG. 1, in accordance with the disclosure; and

FIG. 5 schematically shows a routine associated with on-vehicle compiling of service information for an embodiment of the vehicle 10 described with regard to FIG. 1, in accordance with the disclosure.

It should be understood that the appended drawings are not necessarily to scale, and present a somewhat simplified representation of various features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, technical material that is understood in the related art has not been described in detail in order to avoid unnecessarily obscuring the disclosure. Furthermore, the disclosure, as illustrated and described herein, may be practiced in the absence of an element that is not specifically disclosed herein.

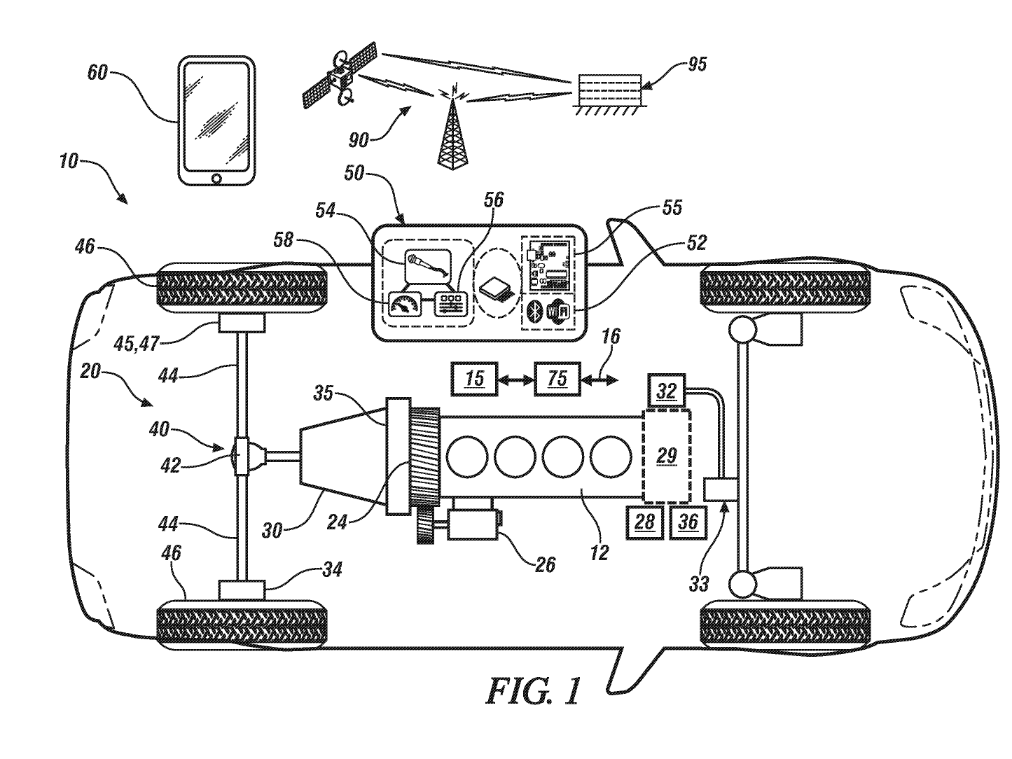

Referring to the drawings, wherein like reference numerals correspond to like or similar components throughout the several Figures, FIG. 1, consistent with embodiments disclosed herein, schematically shows a vehicle 10 including a plurality of subsystems that are associated with vehicle operation, a non-integrated monitoring device 50 that is proximal to the vehicle 10, and a non-integrated communication device 60 that is capable of communicating with the non-integrated monitoring device 50. In one embodiment, the non-integrated communication device 60 includes the non-integrated monitoring device 50. The vehicle 10 is also referred to as a subject vehicle. In one embodiment, the non-integrated monitoring device 50 may be employed in a service environment, and the non-integrated communication device 60 may include another non-integrated monitoring device 50 that is disposed to monitor vehicle operation in-use. The term “non-integrated” is employed herein to describe a stand-alone device that is capable of operating independently from operation of the vehicle 10. Furthermore, a non-integrated device has no connectivity or protocol to effect communication with the vehicle 10. The vehicle 10 may be configured, by way of non-limiting examples, as a passenger vehicle, a light-duty or heavy-duty truck, a utility vehicle, an agricultural vehicle, an industrial/warehouse vehicle, or a recreational off-road vehicle. Other vehicles may include airships and watercraft. The concepts described herein may also be integrated into a monitoring system for a stationary machine, e.g., a stand-alone electric power generator employing an internal combustion engine or a stationary water pump employing an internal combustion engine.

The vehicle 10 is provided to illustrate the concepts described herein. In one embodiment, the vehicle 10 may include an autonomic vehicle control system that is disposed to effect a level of automatic vehicle control. Alternatively, the vehicle 10 may be a non-autonomous vehicle. The vehicle 10 includes a drivetrain 20 that is disposed to generate tractive power for vehicle propulsion in one embodiment. In one embodiment, the drivetrain 20 includes an internal combustion engine 12, a torque converter 35, and a fixed-gear transmission 30 that are coupled to a driveline 40. Alternatively, the drivetrain 20 may include a fuel/electric hybrid system or an all-electric system that employs an electric motor/generator to provide tractive power. Alternatively, the drivetrain 18 may include another device that provides tractive power. The vehicle 10 is configured, in one embodiment, as a four-wheel passenger vehicle with steerable front wheels and fixed rear wheels.

The vehicle 10 is equipped with one or a plurality of components and subsystems associated with vehicle operation whose performance can be evaluated employing the non-integrated monitoring device 50 and the non-integrated communication device 60 when they are proximal to the vehicle 10. Non-limiting examples of the components include as follows. A starter 26 is rotatably coupled to a crankshaft of the engine 12 via a flywheel 24 having a ring gear in one embodiment. An alternator 28 is rotatably coupled to the crankshaft of the engine 12 via a belt drive mechanism 29 in one embodiment. A power steering pump 32 includes a rotatable pumping element that is coupled to the crankshaft of the engine 12 via the belt drive mechanism 29 in one embodiment. Alternatively, the rotatable pumping element of the power steering pump 32 can be coupled to a rotor of an electric motor that is controlled by a controller. The power steering pump 32 is fluidly coupled to a steering actuator 33 to effect vehicle steering. An HVAC system 36 can include a rotatable pumping element that can be coupled to the crankshaft of the engine 12 via the belt drive mechanism 29 in one embodiment. Alternatively, the HVAC system 36 may be arranged in a belt-drive system coupled to the engine 12, as shown, or, alternatively may be arranged in a direct-drive system that is coupled to an electric motor. An engine controller 15 may be disposed to control operation of the engine 12 and associated components, and the engine controller 15 may communicate via a communication bus 16 to a second controller 75, which may operate as a chassis controller, a braking controller or another controller.

The driveline 40 can include a differential 42 that is coupled to drive wheels 46 via axles or half-shafts 44, wherein the drive wheels 46 are coupled to the axles or half-shafts 44 at mounting structures that include wheel bearings 45 and wheel brake devices 47, e.g., disc-brake elements and calipers. The wheel corners may employ suspension dampers 34, which may be either active or passive devices.

The non-integrated communication device 60 is a handheld communication device that is equipped with wireless communication capability, e.g., a cell phone, a satellite phone or another telephonic device.

The non-integrated monitoring device 50 includes one or multiple sensing devices 54, 56, 58 that are in communication with a controller 55. The sensing devices 54, 56, 58 are configured to dynamically monitor a physical parameter such as may be emitted from the vehicle 10. In one embodiment, the sensing device 54 is a microphone capable of capturing audio signal. The microphone 54 can be employed to monitor rotational sounds, such as generated by rotating devices including, by way of non-limiting examples, wheel bearings and associated wheels/axles, the starter 26, the alternator 28, the power steering pump 32, the brake 47, the engine 12 and the transmission 30. In one embodiment, the sensing device 56 is an inertial sensor, e.g., accelerometer and/or a rate gyro. The accelerometer can be employed to dynamically monitor vehicle motion states, including, e.g., vehicle speed, steering angle of the steerable front wheels, and yaw rate. In one embodiment, the sensing device 58 is a temperature sensor.

The non-integrated monitoring device 50 is configured as a stand-alone device that is capable of acquiring various data from built-in sensors. Data is communicated to an app on the non-integrated communication device 60, which communicates to the cloud, i.e., an off-board server 95 for storage and/or analysis.

In one embodiment, the non-integrated communication device 60 and the non-integrated monitoring device 50 can be fabricated as a unitary device, and the communication link 52 is hard-wired to the controller 55 of the communication device 60. Alternatively, the non-integrated communication device 60 is separate and distinct from the non-integrated monitoring device 50, and the non-integrated monitoring device 50 communicates with the non-integrated communication device 60 via the communication link 52, which may be a short-range wireless communication link. The non-integrated communication device 60 communicates via a wireless communication network 90 with the off-board server 95. The off-board server 95 is a physical manifestation of what is commonly referred to as the cloud.

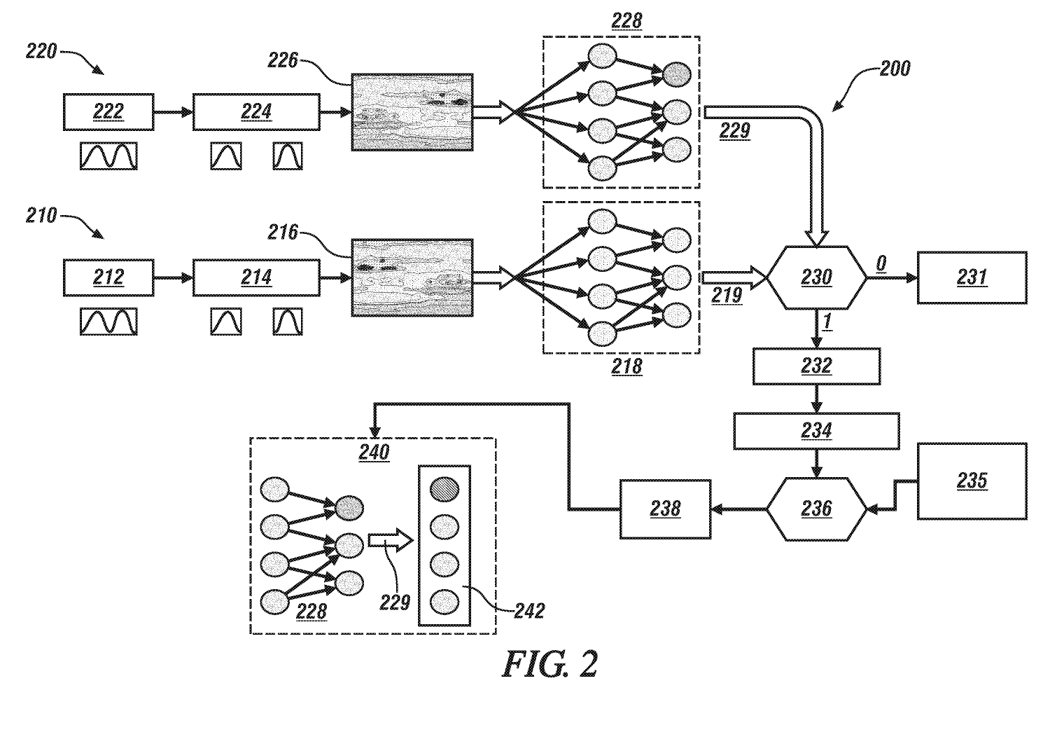

FIG. 2 schematically shows a process 200 for monitoring of components and subsystems associated with vehicle operation whose performance can be evaluated employing the non-integrated monitoring device 50 when it is proximal to the vehicle 10 that is described with reference to FIG. 1. The process 200 includes obtaining a baseline signature 219 for the vehicle 10 (210). The process 200 also includes dynamically monitoring a physical parameter that is being emitted from the vehicle 10 via the non-integrated monitoring device 50, and capturing physical parameter(s) being emitted from the vehicle 10, referred to herein as dynamic data. The dynamic data is analyzed to determine a dynamic signature 229 for the vehicle 10 (220). The baseline signature 219 for the vehicle 10 is compared the dynamic signature 229 for the vehicle 10 (230). When occurrence of a fault associated with a subsystem of the vehicle 10 is detected based upon the comparing of the baseline signature 219 and the dynamic signature 229 for the vehicle 10, such occurrence is communicated as described herein for fault identification and to effect vehicle repair.

The baseline signature 219 includes noise/vibration signatures, spectral noise analysis (e.g., a FFT), vibration energy distribution, and other parametric results that are associated with operation of the vehicle 10 when the vehicle 10 is operating without presence of a fault. The baseline signature 219 for the vehicle 10 can be crowd-sourced as follows (210). Baseline data can be crowd-sourced, i.e., captured from a plurality of vehicles of the same make, model, model year and powertrain, wherein the vehicles supplying the crowd-sourced data are operating without presence of a fault in the components or subsystem(s) of interest (212). The baseline data may be captured from the vehicle 10 itself employing the non-integrated monitoring device 50, stored on-board or in the off-board server 95, and accessed via the wireless communication network 90. Alternatively, the baseline data may be generated by another vehicle that is similarly configured to the vehicle 10, e.g., is the same make, model and production year as the vehicle 10, and has the same powertrain configuration as the vehicle 10. The baseline data can be stored in the off-board server 95 and accessed via the wireless communication network 90. The baseline data is analyzed, including being subjected to quantization (214) and spectral analysis (216), with the resulting data being input to a neural network trainer (218) that employs a feature extraction routine to determine the baseline signature 219. Feature extraction routines associated with neural networks are commercially available. The output of the neural network trainer (218), i.e., the baseline signature 219, is a no-fault trained neural network that is associated with the baseline data that is captured from the vehicle 10 when it is operating without presence of a fault in the components or subsystem(s) of interest. The baseline signature 219 is stored in the off-board server 95.

The dynamic signature 229 for the vehicle 10 can be determined by dynamically monitoring and analyzing a physical parameter that is being emitted from the vehicle 10 via the non-integrated monitoring device 50, referred to herein as dynamic data (222). Emitted physical parameters include, by way of non-limiting examples, acoustic sound, vibration and localized temperature. The acoustic sound may include audible sound, which is in a range between 20 Hz and 20 kHz, infrasound (less than 20 Hz), and ultrasound (greater than 20 kHz). The baseline data may also be captured from the vehicle 10 employing the non-integrated monitoring device 50 and stored in the off-board server 95. The dynamic data is analyzed, including being subjected to quantization (224) and spectral analysis (226), with the resulting data being input to a neural network trainer (228) that employs a feature extraction routine to determine the dynamic signature 229. The foregoing steps are analogous to the steps 212, 214, 216 and 218 associated with determining the baseline signature 229. The output of the neural network trainer (228), i.e., the dynamic signature 229, is a neural network that is associated with the dynamic data that is captured from the vehicle 10.

The dynamic signature 229 is compared to the baseline signature 219 (230) to detect occurrence of an anomaly in the dynamic signature 229 that may be associated with a fault in a subsystem or component of the vehicle 10. When no anomaly is detected (230)(0), the evaluation ends without further action (231). When an anomaly is detected (230)(1), the anomaly is quantized (232), and communicated to a service facility (234). The service facility combines the information from the anomaly with a service assessment (235) to identify a fault and an associated root cause of the identified fault (236). A specific service routine can be executed to repair the vehicle 10 in a manner that addresses the root cause of the fault (238). The specific service routine may include replacing a faulty component, adjusting a belt tensioner, repairing/replacing a wiring harness connector, etc. The resulting outcome is input to a neural net trainer 240, which correlates the dynamic signature 229 with the identified fault and the specific service routine that addresses the root cause of the fault, and communicates such input to the off-board server 95 to update a fault dictionary 242. The neural net trainer 240 may be stored in and executed by the off-board server 95. The updated fault dictionary 242 may be stored in and accessible from the off-board server 95 via the wireless communication network 90. The contents of the fault dictionary 242 correlate to the dynamic signature 229. There may be a dynamic signature 229 associated with each root cause of a fault and an associated service routine.

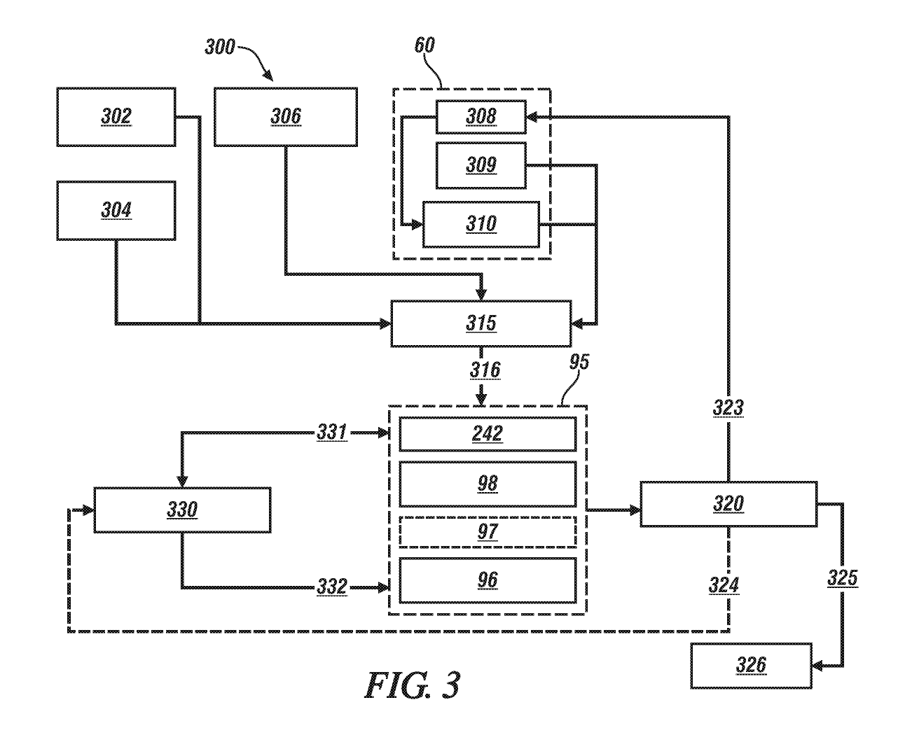

FIG. 3 schematically shows a process 300 for implementing the concepts described herein with regard to FIGS. 1 and 2. Information associated with the vehicle 10 can be captured from several devices and systems and communicated to a controller 315 for collection, data analysis, and data compression in preparation for communication (316) to the off-board server 95 as dynamic data 320 that is specific to the operation of the vehicle 10. The controller 315 corresponds to the controller 55 of the non-integrated monitoring device 50 in one embodiment.

The information can include vehicle make, model, model year and odometer reading (304), which may be captured via an ALDL (Assembly Line Diagnostic Link) connector or manually entered by a service technician. The information can include DTC (diagnostic trouble code) information (302), which may be captured via a scan tool or another device that is linked to the ALDL connector, such as a connected car system. The information can include non-integrated sensory data (306) from a non-integrated sensory and processing unit that is mounted at a location on the vehicle 10, e.g., underhood. In one embodiment, the non-integrated sensory and processing unit can be the non-integrated monitoring device 50 that is proximal to the vehicle 10 and described herein. In one embodiment, the non-integrated monitoring device 50 may be proximal to the vehicle 10 for data capture and analysis when the vehicle 10 is stationary, i.e., not moving. In one embodiment, the non-integrated monitoring device 50 may be disposed on the vehicle 10 for data capture and analysis when the vehicle 10 is stationary and under dynamic operating conditions, i.e., when the vehicle 10 is traversing a road surface. The information can include data captured via an in-vehicle smartphone, e.g., phone 60 (308), wherein the smartphone includes a microphone disposed to monitor ambient sound (309) and/or an accelerometer that is disposed to monitor vehicle motion (310).

The vehicle make, model, model year and odometer reading (304), the DTC information (302), the non-integrated sensory data (306), and the ambient sound (309) and vehicle motion (310) are communicated to the controller 315 for collection, data analysis, and data compression in preparation for being communicated as dynamic data 320 to the off-board server 95.

The controller 315 can communicate the collected information to the off-board server 95 in response to a query from the off-board server 95, or in response to a command that may be generated by the controller 315. The controller 315 may detect an anomalous datapoint in the dynamic data 320 that indicates an impending need for vehicle service, along with a request to alert the vehicle operator and/or another interested individual such as a mechanic, a fleet operator, a vehicle owner, or a shop foreman at a service center. An anomalous datapoint may be generated by the DTC information (302), the non-integrated sensory data (306), or the ambient sound (309) and vehicle motion (310) generated by the in-vehicle smartphone 60.

The off-board server 95 includes databanks and other memory devices that may be employed to house, process and disseminate processed information from a plurality of sources, including a plurality of vehicles, technical experts, etc.

The off-board server 95 includes a central information processing center 97 that is in communication with a multitude of databanks 96, preferably including the fault dictionary 242, and may be queried via a central information dissemination server 98. The databanks 96 are electronic repositories for service and maintenance information that are related to individual vehicle makes, models, and model years and or individual machines. Service technicians are able to access vehicle-specific data or machine-specific data from the central information processing center 97, and submit vehicle-specific data to the central information processing center 97 based upon their repair experience. In one embodiment, the central information processing center 97 may be made available in the form of a wiki site, thus allowing multiple users to collaboratively modify and update vehicle-specific content and machine-specific content.

A service technician can query the off-board server 95 to obtain make/model/model year-specific information that can be employed to evaluate and diagnose a specific fault. The service technician can submit diagnostic and repair information to the off-board server 95 to enhance the content of the one of the databanks 96 associated with the make/model/model year.

The off-board server 95 can convey information to the service technician (324), to the vehicle operator via the in-vehicle smartphone 60 (323), and to a regional parts distribution center 326 (325). The off-board server 95 can convey such information in response to an inquiry from the service technician, or in response to the controller 315 detecting an anomalous datapoint in the dynamic data 320 that indicates an impending need for vehicle service, along with a request to alert the vehicle operator and/or the vehicle service center and/or the regional parts distribution center 326.

When the off-board server 95 conveys information to the service technician (324), the service technician interrogates the off-board server 95 to understand and diagnose the nature(s) of a root cause associated with the fault (331). When a root cause associated with the fault is identified and verified, the service technician communicates such results to the off-board server 95 (332) to populate the databank 96.

The term “controller” and related terms such as control module, module, control, control unit, processor and similar terms refer to one or various combinations of Application Specific Integrated Circuit(s) (ASIC), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine-readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions. Routines may be executed at regular intervals, for example each 100 microseconds during ongoing operation. Alternatively, routines may be executed in response to occurrence of a triggering event. The term ‘model’ refers to a processor-based or processor-executable code and associated calibration that simulates a physical existence of a device or a physical process. The terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine. The terms “calibration”, “calibrate”, and related terms refer to a result or a process that compares an actual or standard measurement associated with a device with a perceived or observed measurement or a commanded position. A calibration as described herein can be reduced to a storable parametric table, a plurality of executable equations or another suitable form.

Communication between controllers, and communication between controllers, servers, actuators and/or sensors may be accomplished using a direct wired point-to-point link, a networked communication bus link, a wireless link or another suitable communication link. Communication includes exchanging data signals in suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers. The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium. A parameter is defined as a measurable quantity that represents a physical property of a device or other element that is discernible using one or more sensors and/or a physical model. A parameter can have a discrete value, e.g., either “1” or “0”, or can be infinitely variable in value.

The terms “prognosis”, “prognostics”, and related terms are associated with data monitoring and algorithms and evaluations that render an advance indication of a likely future event associated with a component, a subsystem, or a system. Prognostics can include classifications that include a first state that indicates that the component, subsystem, or system is operating in accordance with its specification (“Green” or “G”), a second state that indicates deterioration in the operation of the component, subsystem, or system (“Yellow” or “Y”), and a third state that indicates a fault in the operation of the component, subsystem, or system (“Red” or “R”). The terms “diagnostics”, “diagnosis” and related terms are associated with data monitoring and algorithms and evaluations that render an indication of presence or absence of a specific fault with a component, subsystem or system. The term “mitigation” and related terms are associated with operations, actions or control routine that operate to lessen the effect of a fault in a component, subsystem or system.

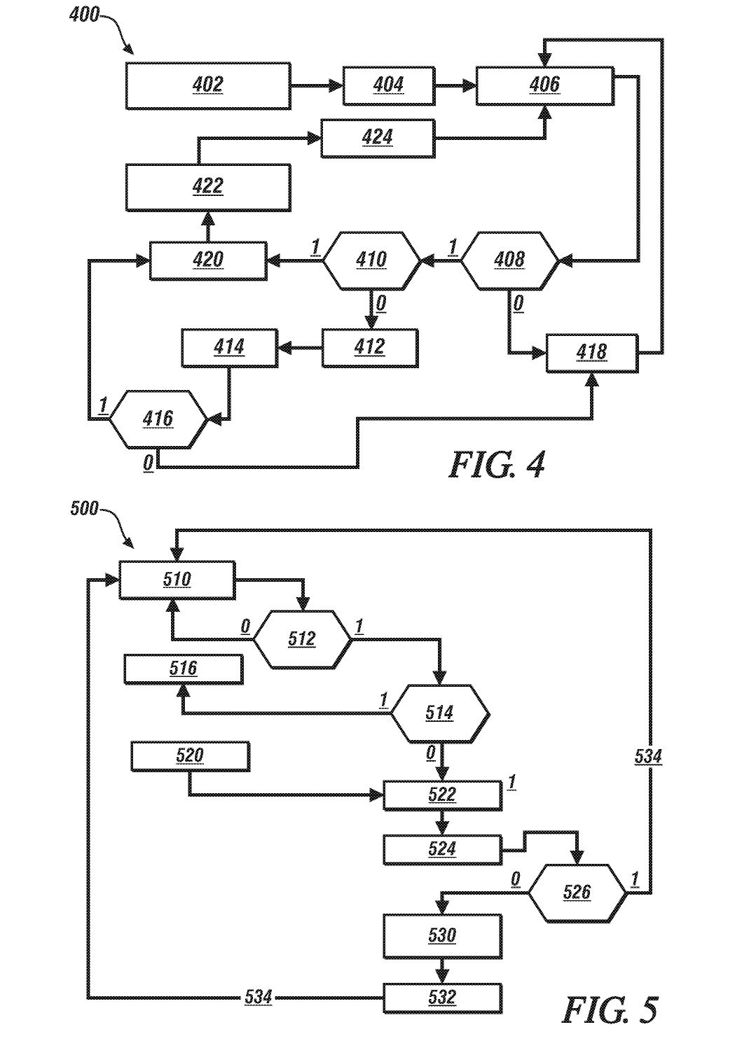

FIG. 4 schematically shows a routine 400 associated with compiling and communicating service information by a service technician that is engaged in monitoring, fault diagnostics, repair and updating service information for an embodiment of the vehicle described with regard to FIG. 1, employing an embodiment of the process 200 for monitoring of components and subsystems associated with vehicle operation whose performance can be evaluated employing the non-integrated monitoring device 50 that is described with reference to FIG. 2 and further reference to FIG. 3.

Table 1 is provided as a key wherein the numerically labeled blocks and the corresponding functions are set forth as follows, corresponding to the routine 400. The teachings may be described herein in terms of functional and/or logical block components and/or various processing steps. It should be realized that such block components may be composed of hardware, software, and/or firmware components that have been configured to perform the specified functions.

TABLE 1

| BLOCK | BLOCK CONTENTS |
|---|---|
| 402 | Pre-Service |
| 404 | Upload dynamic data |
| 406 | Process and catalog information |
| 408 | Interrogate library for baseline signature |
| 410 | Compare baseline and dynamic data to detect fault |
| 412 | Communicate likely fault to service technician |
| 414 | Generate probabilistic estimate |
| 416 | Is fault probability high? |
| 418 | Capture dynamic data as healthy data |
| 420 | Communicate fault probability to service technician |

Execution of the routine 400 may proceed as follows, although the steps of the routine 400 may be executed in a suitable order, and are not limited to the order depicted. As employed herein, the term “1” indicates an answer in the affirmative, or “YES”, and the term “0” indicates an answer in the negative, or “NO”.

When there is an indication of a fault that causes a vehicle operator or another interested individual to seek service for the vehicle, pertinent information is captured prior to executing the vehicle service (402). The pertinent information includes the vehicle make, model, model year and odometer reading, VIN (vehicle identification number), DTC information, and dynamic data from which the dynamic signature 229 can be determined, including the non-integrated sensory data and/or the ambient sound, temperature and vehicle motion data that is captured from the non-integrated monitoring device 50. The dynamic signature 229 can be determined by an on-vehicle controller, or the non-integrated sensory data and/or the ambient sound, temperature and vehicle motion data can be communicated to the off-board server 95 to be generated.

The pertinent information is communicated to the off-board server 95 (404), which processes and catalogs the information (406).

The pertinent information is employed to interrogate the databank 96 of the off-board server 95 to determine it contains a baseline signature 219 for the vehicle 10. When the off-board server 95 contains the baseline signature 219, the dynamic signature 229 is compared to the baseline signature 219 to identify a potential fault (410).

When a potential fault is indicated by the comparison (410)(0), the result is shared with the service technician that is working on the vehicle 10 to assist in fault isolation and vehicle repair (412), and a probabilistic fault estimate is generated (414) and evaluated (416). When the fault probability is high (416)(1), the fault probability is shared with the service technician that is working on the vehicle 10 (420). When the fault probability is low (416)(0), the dynamic signature 229 is captured and recorded as indicating that the vehicle 10 is operating without a fault, i.e., healthy (418), and this information is communicated to the off-board server 95 to catalog the information (406).

When no potential fault is indicated by the comparison (410)(1), the result is shared with the service technician that is working on the vehicle 10 (420).

When vehicle service has been successfully completed, the pertinent information is captured, including the vehicle make, model, model year and odometer reading, VIN, DTC information, and dynamic data. The pertinent information can be captured from the non-integrated monitoring device 50 (422), evaluated and recorded (424) and catalogued (406) for storage in the off-board controller 95 for future reference.

In this manner, the process can facilitate fault diagnosis for similar problems, thus increasing repair efficiency and helping mechanics be more data driven. For example, when a vehicle operator detects a problem that has a signature noise, a technician can upload data to the database when a repair has been successfully completed. Thus, the next time a person with the same/similar vehicle has a similar noise, the repair technician has a service road map for identifying a fault, and could also have the part already ordered.

FIG. 5 schematically shows a routine 500 associated with on-vehicle compiling of service information for an embodiment of the vehicle 10 described with regard to FIG. 1, employing an embodiment of the process 200 for monitoring of components and subsystems associated with vehicle operation whose performance can be evaluated employing the non-integrated monitoring device 50 that is described with reference to FIG. 1. Table 2 is provided as a key wherein the numerically labeled blocks and the corresponding functions are set forth as follows, corresponding to the routine 500. The teachings may be described herein in terms of functional and/or logical block components and/or various processing steps. It should be realized that such block components may be composed of hardware, software, and/or firmware components that have been configured to perform the specified functions.

TABLE 2

| BLOCK | BLOCK CONTENTS |
|---|---|
| 510 | Case 1: Data is available |
| 512 | Evaluate dynamic data to detect anomaly |
| 514 | Can anomaly be labelled? |
| 516 | Notify operator |
| 520 | Case 2: No data is available |
| 522 | Share dynamic data |
| 524 | Generate probabilistic estimate |
| 526 | Is fault probability high? |
| 534 | Update records |
| 530 | Notify operator of need for service |
| 532 | Complete service |
| 534 | Update records |

Execution of the routine 500 may proceed as follows, although the steps of the routine 500 may be executed in a suitable order, and are not limited to the order depicted. As employed herein, the term “1” indicates an answer in the affirmative, or “YES”, and the term “0” indicates an answer in the negative, or “NO”.

When vehicle data has been captured (510), i.e., when dynamic data is available from which the dynamic signature 229 can be determined, it is evaluated either on-board or off-board to detect occurrence of an anomaly (512). The dynamic data includes the non-integrated sensory data and/or the ambient sound, temperature and vehicle motion data that is captured from the non-integrated monitoring device 50. When no anomaly is detected (512)(0), this iteration ends until the dynamic data has been updated. When an anomaly is detected (512)(1), the routine determines whether the anomaly can be labelled or categorized to indicate a likely area or system that may have a fault (514). When the anomaly can be labelled or categorized (514)(1), the vehicle operator is notified of the likely area or system that may have a fault (516), and this iteration ends.

When the anomaly cannot be labelled or categorized based upon the anomaly detection process (514)(1), and/or when no relevant vehicle data has been captured (520), the available information, if any, is communicated to an attending service technician (522) to assist in fault isolation and vehicle repair. A probabilistic fault estimate is generated (524) and evaluated (526). When the fault probability is high (526)(1), the fault probability is employed to update stored data records for the vehicle 10 (534), and this iteration ends. When the fault probability is low (526)(0), the vehicle operator is notified that there is a need to service the vehicle 10, albeit without identifying the likely area or system having a fault (530). When vehicle service is completed by a service technician and a root cause and service procedure has been identified (532), the stored data records for the vehicle 10 are updated with that information (534) and this iteration ends.

The concepts described herein employ crowd-sourced vehicle data, in the form of acoustic noise, sound, accelerometer, and OBD codes for diagnosis and prognosis of faults in various types of vehicles. In one embodiment, a stand-alone aftermarket hardware device can be mounted under-hood in a vehicle, and can periodically pair with an operator's smartphone to send the vehicle data to the cloud, i.e., the remote server 95. The vehicle data is compared against other vehicles of the same make/model, and notifications are sent to the operator when the vehicle data, e.g., sound is correlated to a fault. When there is insufficient data for the same vehicle make/model, the signature may be compared data from similar vehicles, e.g., those employing the same or similar internal combustion engine or propulsion motor and/or other components notifications are sent to the operator when the vehicle data, e.g., sound is correlated to a fault.

When the vehicle data does not correlate to a fault, the operator is still notified. The operator can also actively employ their smartphone, via an associated application, to send vehicle data to the cloud directly for evaluation. As such, a crowd-sourcing technique can be leveraged to assist a vehicle operator to efficiently detect and diagnose vehicle problems.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method for monitoring a subject vehicle, the method comprising:
monitoring, via a non-integrated sensor, a physical parameter emitted from the subject vehicle;
determining a dynamic signature associated with the physical parameter being emitted from the subject vehicle;
obtaining a baseline signature for the subject vehicle;
comparing the baseline signature for the subject vehicle and the dynamic signature for the subject vehicle;
detecting occurrence of a fault in a subsystem of the subject vehicle based upon the comparing of the baseline signature for the subject vehicle and the dynamic signature for the subject vehicle; and
communicating the occurrence of the fault to an operator of the subject vehicle.

2. The method of claim 1, wherein the non-integrated sensor is disposed proximal to the subject vehicle.

3. The method of claim 1, wherein monitoring, via the non-integrated sensor, a physical parameter being emitted from the subject vehicle comprises monitoring acoustic sound via a non-integrated microphone.

4. The method of claim 1, wherein the physical parameter comprises acoustic sound, and wherein determining the dynamic signature comprises executing a frequency spectrum analysis of the acoustic sound being emitted from the subject vehicle.

5. The method of claim 1, wherein monitoring, via the non-integrated sensor, a physical parameter being emitted from the subject vehicle comprises monitoring vibration via a non-integrated accelerometer.

6. The method of claim 1, wherein monitoring, via the non-integrated sensor, a physical parameter being emitted from the subject vehicle comprises monitoring temperature via a non-integrated temperature sensor.

7. The method of claim 1, wherein the subsystem includes a rotatable element, and wherein determining the dynamic signature associated with the physical parameter being emitted from the subject vehicle comprises determining a dynamic signature corresponding to a rotational speed of the rotatable element.

8. The method of claim 1, wherein obtaining baseline data for the subject vehicle comprises accessing, via a telematics device, a database stored on a remotely located server to obtain the baseline data for the subject vehicle.

9. The method of claim 8, further comprising uploading the dynamic signature to the database stored on the remotely located server.

10. The method of claim 1, wherein the baseline signature for the subject vehicle is crowd-sourced.

11. A method for monitoring a machine, the method comprising:
monitoring, via a non-integrated sensor, a physical parameter emitted from the machine;
determining a dynamic signature associated with the physical parameter being emitted from the machine;
obtaining a baseline signature for the machine;
comparing the baseline signature for the machine and the dynamic signature for the machine;
detecting occurrence of a fault in a subsystem of the machine based upon the comparing of the baseline signature for the machine and the dynamic signature for the machine; and
communicating the occurrence of the fault to an operator of the machine.

12. The method of claim 11, wherein the non-integrated sensor is disposed proximal to the machine.

13. The method of claim 11, wherein monitoring, via the non-integrated sensor, a physical parameter being emitted from the machine comprises monitoring acoustic sound via a non-integrated microphone.

14. The method of claim 11, wherein the physical parameter comprises acoustic sound, and wherein determining the dynamic signature comprises executing a frequency spectrum analysis of the acoustic sound being emitted from the machine.

15. The method of claim 11, wherein monitoring, via the non-integrated sensor, a physical parameter being emitted from the machine comprises monitoring vibration via a non-integrated accelerometer.

16. The method of claim 11, wherein monitoring, via the non-integrated sensor, a physical parameter being emitted from the machine comprises monitoring temperature via a non-integrated temperature sensor.

17. The method of claim 11, wherein the subsystem includes a rotatable element, and wherein determining the dynamic signature associated with the physical parameter being emitted from the machine comprises determining a dynamic signature corresponding to a rotational speed of the rotatable element.

18. The method of claim 11, wherein obtaining baseline data for the machine comprises accessing, via a telematics device, a database stored on a remotely located server to obtain the baseline data for the machine.

19. The method of claim 18, further comprising uploading the dynamic signature to the database stored on the remotely located server.

20. A device for monitoring a subject vehicle, comprising:
non-integrated monitoring device including a sensor disposed to monitor a physical parameter;
a non-integrated communication device disposed to communicate with the non-integrated monitoring device; and
a controller in communication with the non-integrated communication device, the controller including an instruction set, the instruction set executable to:
monitor, via the non-integrated monitoring device, a physical parameter being emitted from the subject vehicle,
determine a dynamic signature associated with the physical parameter being emitted from the subject vehicle,
obtain a baseline signature for the subject vehicle,
compare the baseline signature for the subject vehicle and the dynamic signature for the subject vehicle,
detect occurrence of a fault in a subsystem of the subject vehicle based upon the comparison of the baseline signature for the subject vehicle and the dynamic signature for the subject vehicle, and
communicate the occurrence of the fault to an operator of the subject vehicle.
